(19) United States
(12) Patent Application Publication
(10) Pub. No.: US 2026/0299921 A1
(43) Pub. Date: Oct. 1, 2026

(54) Firmware Wireless Update System and Method Thereof

(71) Applicants: HYUNDAI MOTOR COMPANY, SEOUL (KR); KIA CORPORATION, SEOUL (KR)

(72) Inventor: Jae Young Han, Hwaseong-si (KR)

(73) Assignees: HYUNDAI MOTOR COMPANY, SEOUL (KR); KIA CORPORATION, SEOUL (KR)

(21) Appl. No.: 19/283,131

(22) Filed: Jul. 28, 2025

(30) Foreign Application Priority Data
Mar. 28, 2025 (KR) 10-2025-0040088

(51) Int. Cl. G06F 8/65; G06F 21/57; G06F 21/64; H04L 67/12

(52) U.S. Cl. CPC G06F 8/65; G06F 21/572; G06F 21/64; H04L 67/12

(57) ABSTRACT

A firmware wireless update system includes a robot control server and at least one robot. The at least one robot may include a main controller and a module having a processor. The module being configured to communicate with the main controller. When the main controller delivers firmware to the processor via communication based on a firmware update command of the robot control server, the processor is configured to perform a firmware update on the module.

### CROSS-REFERENCE TO RELATED APPLICATION

This application claims the benefit of and priority to Korean Patent Application No. 10-2025-0040088, filed in the Korean Intellectual Property Office on Mar. 28, 2025, the entire contents of which are incorporated herein by reference.

### TECHNICAL FIELD

The present disclosure relates to a firmware wireless update system and a method thereof. More particularly, the present disclosure relates to a technology for wirelessly updating firmware of various kinds function modules provided in a device, which uses controller area network (CAN) communication, such as a robot or a vehicle by using the CAN communication.

### BACKGROUND

Nowadays, various devices developed with the development of Internet of Things (IoT) technologies are installed and used in the field. As digitization technologies are combined with various devices and new business models emerge, new IoT devices are being introduced for various roles beyond existing functions. The IoT devices are implemented and operated in the form of an operating program or firmware. However, for the addition or improvement of new functions or for the stability, there is a desire to modify the firmware.

For this reason, the FOTA (Firmware Over the Air), which is a solution for automatically updating firmware wirelessly, was developed. The firmware is received from an upper management server, and the received firmware allows the IoT devices to automatically execute the update (or upgrade). Herein, the firmware generally refers to a micro-program, which controls hardware stored in a nonvolatile memory (e.g., an Electrically Erasable Programmable Read-Only Memory (EEPROM) or a flash memory). The firmware is the same as software from the perspective of a program but is distinguished from general application software in that the firmware includes a close relationship with hardware. The firmware is responsible for the basic operation and initialization of hardware. The firmware includes characteristics of the software and the hardware, which enables the hardware operation and the control of basic functions.

When the FOTA service is used, a user is capable of modifying the firmware without directly visiting a service center for firmware update or is capable of downloading an improved program to directly update the firmware.

However, the FOTA technology is currently limited to certain devices. Because the firmware is not an OS-based program, a network layer does not mostly exist therein, thereby making it difficult to use standard data transmission methods. According to the above description, FOTA technology is incapable of being applied to a technology field associated with a robot and a vehicle that mainly use controller area network (CAN) communication with a limited bandwidth and a communication ID. For this reason, the use of the FOTA technology in the technology field associated with a robot and a vehicle causes significant inconvenience that the user directly visits the service center for firmware update.

Nowadays, with the advancement of individual device modules used in robots and vehicles, there is a growing demand for wirelessly firmware updates to support the implementation of additional functions. Accordingly, firmware update technology is essentially desired in the technology field in which CAN communication is used. Also, considering production costs or the like, because the probability that CAN communication will be widely used across various fields, a firmware wireless update technology specialized for CAN communication is inevitably desired.

### SUMMARY

The present disclosure was made to solve the above-mentioned technical issues occurring in the prior art while advantages achieved by the prior art are maintained intact.

An aspect of the present disclosure provides a system for firmware wireless update capable of wirelessly updating firmware of an update-targeted module in which controller area network (CAN) communication is used and a method thereof.

An aspect of the present disclosure provides a system for wirelessly updating firmware of an update-targeted module while checking the integrity of firmware and a method thereof.

An aspect of the present disclosure provides a system capable of wirelessly updating firmware of an update-targeted module being in a paused state and a method thereof.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, a system for a firmware wireless update includes a robot control server and the at least one robot. The at least one robot includes a main controller and a module having a processor. The module is configured to communicate with the main controller. The main controller performs a firmware update of the processor based on a firmware update command of the robot control server.

In an embodiment, the robot control server and the at least one robot may be connected via a wireless network. The main controller and the processor may be connected via a CAN bus to perform the firmware update via CAN communication.

In an embodiment, the at least one robot may further include a storage device configured to store encrypted firmware transmitted by the robot control server, and a memory loaded to decrypt the encrypted firmware at a point in time of the firmware update. The main controller may be configured to: decrypt the encrypted firmware when a command of the firmware update occurs; split the decrypted firmware into packets of a predetermined size; and deliver the packets to the processor. The decrypted firmware is deleted from the memory.

In an embodiment, the robot control server encrypts firmware to include information about a robot to be updated at a firmware build and module information provided in each of the at least one robot.

In an embodiment, the main controller may decrypt the encrypted firmware at a point in time at which CAN communication starts.

In an embodiment, the main controller may allocate bus usage for each module based on the number of modules performing the firmware update, and usage of the CAN bus. The main controller may also determine an individual transfer rate, and may transmit firmware to each module.

In an embodiment, the main controller may perform a firmware integrity check on the encrypted firmware based on a specification file. The processor may check firmware integrity when firmware is completely transmitted via CAN communication.

In an embodiment, the processor may perform an error check on each line while receiving packet data of the firmware, and may perform an integrity check on the entire firmware when all lines are received.

In an embodiment, the module further includes an internal memory. The processor may update firmware delivered by the main controller to a firmware area of the internal memory, which is being used, when an operation of the module is suspended, and may resume the operation of the module by the updated firmware.

In an embodiment, the processor may perform the firmware update again when restoring to an initial program when the firmware update is not performed.

According to an aspect of the present disclosure, a method for wirelessly updating firmware using a system including a robot control server and at least one robot having a main controller and a module with a processor is provided. The method includes communicating, via the module, with the main controller. The method also includes performing, via the main controller, a firmware update of the processor based on a firmware update command of the robot control server.

In an embodiment, the robot control server and the at least one robot may be connected via a wireless network. The main controller and the processor may be connected via a CAN bus to perform the firmware update via CAN communication.

In an embodiment, the at least one robot may further include a storage device that stores encrypted firmware transmitted by the robot control server, and a memory loaded to decrypt the encrypted firmware at a point in time of the firmware update. The method further includes: determining, via the main controller, whether to decrypt the encrypted firmware when a command of the firmware update occurs; splitting, via the main controller, the decrypted firmware into packets of a predetermined size; and delivering, via the main controller, the packets to the processor. The decrypted firmware is deleted from the memory.

In an embodiment, the method further includes encrypting, via the robot controller, firmware to include information about a robot to be updated at a firmware build and module information.

In an embodiment, the method further includes decrypting, via the main controller, the encrypted firmware at a point in time at which CAN communication starts.

In an embodiment, the method further includes allocating, via the main controller, bus usage for each module based on the number of modules performing the firmware update, and usage of the CAN bus. The method may further include determining, via the main controller, an individual transfer rate, and transmitting, via the main controller, firmware to each module.

In an embodiment, the method may further include performing, via the main controller, a firmware integrity check on the encrypted firmware based on a specification file. The method may also include determining, via the processor, whether to check firmware integrity when firmware is completely transmitted via CAN communication.

In an embodiment, the method may further include performing, via the processor, an error check on each line while receiving packet data of the firmware, and determining, via the processor, whether to perform an integrity check on entire firmware again when all lines are received.

In an embodiment, the module further includes an internal memory. The method further includes updating, via the processor, firmware delivered by the main controller to a firmware area of the internal memory, which is being used, when an operation of the module is suspended, and resuming, via the processor, the operation of the module by the updated firmware.

In an embodiment, the method may further include determining, via the processor, whether to perform the firmware update after restoring to an initial program when the firmware update is not performed.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating a configuration of a system for a firmware wireless update, according to an embodiment of the present disclosure;

FIG. 2 is a drawing illustrating a database that stores and manages firmware of a robot illustrated in FIG. 1 for each version and each target;

FIG. 3 is a block diagram illustrating a configuration of the robot device illustrated in FIG. 1;

FIG. 4 is an overall flowchart illustrating a firmware wireless update process, according to an embodiment of the present disclosure;

FIG. 5 is a flowchart illustrating in detail a process in that a robot control server delivers firmware data to a robot, according to another embodiment of the present disclosure;

FIG. 6 is a flowchart illustrating a process, in which a main controller transmits firmware stored in a storage device to a processor, according to another embodiment of the present disclosure;

FIG. 7 is a flowchart illustrating a firmware update process of a processor, according to another embodiment of the present disclosure;

FIG. 8 is a flowchart describing a firmware integrity check process, according to another embodiment of the present disclosure;

FIG. 9 is a flowchart describing a firmware update process in detail, according to another embodiment of the present disclosure;

FIGS. 10A-10D are example diagrams illustrating a process of updating firmware in an internal memory, according to another embodiment of the present disclosure; and

FIG. 11 is a block diagram illustrating a computing system, according to an embodiment of the present disclosure.

### DETAILED DESCRIPTION

Hereinafter, some embodiments of the present disclosure are described in detail with reference to the accompanying drawings. In adding reference numerals to components of each drawing, it should be noted that the same components include the same reference numerals, although they are indicated on another drawing. Furthermore, in describing the embodiments of the present disclosure, detailed descriptions associated with well-known functions or configurations have been omitted when they may make subject matters of the present disclosure unnecessarily obscure.

In describing elements of an embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms used herein, including technical or scientific terms, include the same meaning as commonly understood by one of ordinary skill in the art to which the present disclosure belongs. It should be understood that terms used herein should be interpreted as including a meaning that is consistent with their meaning in the context of the present disclosure and the relevant art and should not be interpreted in an idealized or overly formal sense unless expressly so defined herein.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus

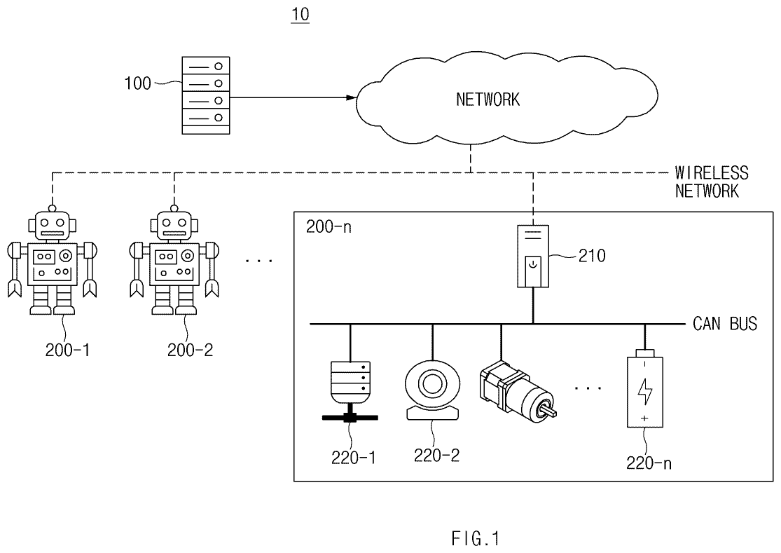

Hereinafter, embodiments of the present disclosure are described in detail with reference to FIGS. 1 to 11.

FIG. 1 is a block diagram illustrating a configuration of a system for a firmware wireless update, according to an embodiment of the present disclosure.

Referring to FIG. 1, a system 10 (hereinafter referred to as a “system” of the present disclosure) for a firmware wireless update according to an embodiment of the present disclosure may include a robot control server 100 and robot devices 200 (200-1, 200-2, . . . , 200-n).

The robot control server 100 and the robot devices 200 may be connected to each other via a communication interface. In an embodiment, the communication interface may include various wireless networks, such as a short-range wireless communication network, a wireless communication network, and the like. The short-range wireless communication network may be a network for communicating in a short-range wireless communication method such as Bluetooth (BT), Bluetooth Low Energy (BLE), or ZigBee. Moreover, the wireless communication network may be a wireless personal area network (WPAN), Wi-Fi (IEEE 802.11), wireless local area network (WLAN), low power WLAN, ZigBee, or CSMA-based wireless network. Furthermore, the communication method may be a communication that collaborates with the Internet, local area networks (LANs), wide area networks (WANs), virtual private networks (VPNs), and a cloud, or other possible forms of communication.

In an embodiment, the robot control server 100 may store firmware to be updated in the robot device 200 and may manage Firmware Over the Air (FOTA) based on predetermined rules.

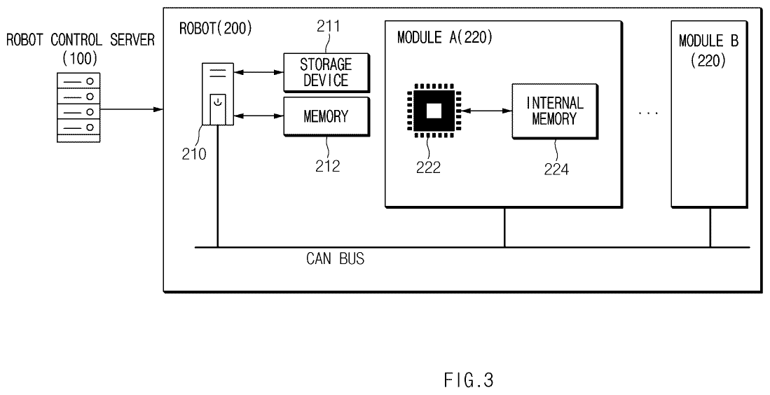

In an embodiment, the robot 200 may include a main controller 210 and a plurality of modules 220 (220-1, 220-2, . . . , 220-n) connected to the main controller 210 via a controller area network (CAN) bus. The modules do not necessarily include a plurality of modules, and only a single module may be provided based on the type or characteristics of the robot. A configuration of the robot 200 is described in detail with reference to FIG. 3. However, in an embodiment, the robot 200 is described with an example. However, it may be applied to various devices belonging to the technical field where the connection between the modules 220 needs to be connected via a CAN communication method. Moreover, it is natural that a communication protocol structure using a communication method of a similar concept, such as EtherCAT, may be applied in addition to CAN communication.

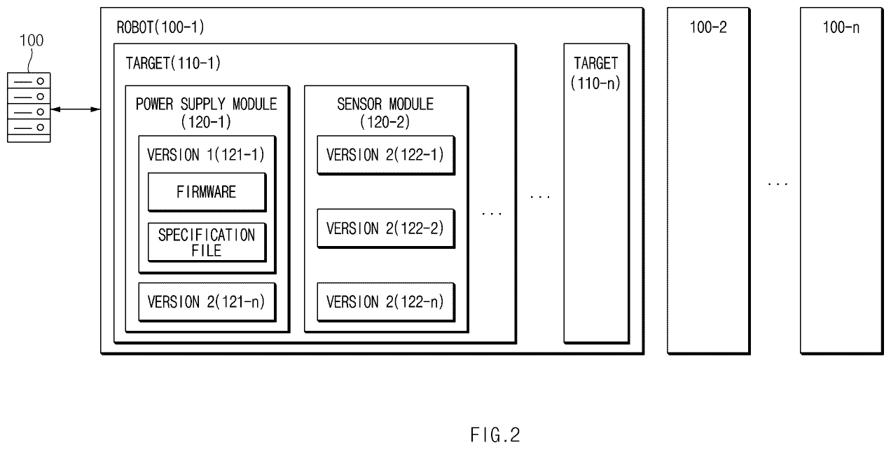

FIG. 2 is a drawing illustrating a database that stores and manages firmware of a robot illustrated in FIG. 1 for each version and each target.

Referring to FIG. 2, the robot control server 100 may categorize, store, and manage firmware in a database (not shown) for each robot type (100-1, ~100-n), each target (110-1~110-n), each module (120-1, 120-2, ~), and each version (121-1, 121-n, 122~1, 122-n, ~).

Moreover, development data may be provided for each version (121, 122~). The development data may consist of encrypted firmware and a specification file including related information and an encryption key. As shown in FIG. 2, each module may include pieces of development data with different versions and may be operated based on firmware for each version.

FIG. 3 is a block diagram illustrating a configuration of the robot device illustrated in FIG. 1.

In FIG. 3, the robot device 200 may be configured to include the main controller 210 and the modules 220. The main controller 210 and each of the modules 220 may be connected to a CAN bus. The main controller 210 includes a structure capable of controlling a plurality of modules. The main controller 210 may be a controller, of which the level is higher than a general processor, and may refer to an “OS-based processor”, and may include a storage device 211 and a memory 212. Although shown separately in FIG. 3, it should be understood that the storage device 211 and the memory 212 are provided within the main controller 210. The storage device 211 may refer to a non-volatile storage device, such as a solid state drive (SSD), a hard disk drive (HDD), or a SD card, and the memory 212 may refer to a volatile memory, such as a random access memory (RAM).

The main controller 210 may inquire state information of each of the modules 220 based on the command of the robot control server 100, may check the integrity of the encrypted firmware, may decrypt the encrypted firmware, may deliver the decrypted firmware to each of the modules 220, and may provide a firmware update command. The main controller 210 may be used as a gateway for network communication with the robot control server 100.

The memory 212 may be firmware storage capable of storing the encrypted firmware. The encrypted firmware may be stored in the storage device 211; the firmware decrypted via the decryption process is not stored in the storage device 211; and at a point in time at which the firmware is updated, the encrypted firmware may be decrypted only in a memory area and may be transmitted to each module 220. Moreover, the decrypted firmware will be removed if the operation of the robot 200 is terminated or the memory 212 is not used.

The module 220 may include a processor 222 for controlling operations of modules, and an internal memory 224. The processor 222 may communicate with the main controller 210 via the CAN bus. Furthermore, the internal memory 224 may be a memory configured to be set for security such that access is difficult from the outside. Although illustrated in the drawing as a separate configuration from the processor 222, the internal memory 224 may be implemented within the processor 222.

The module 220 may be configured to perform various functions of the robot 200. The module 220 may refer to a module performing various functions of the robot 200, and may include modules for functions such as control, power supplies, sensors, communication, and storage. The modules 220 may perform individually assigned operations or may perform specific operations while a plurality of modules are physically coupled to each other based on the required function. Besides, as mentioned above, the module 220 may require firmware updates for reasons such as adding or improving new features or stability.

According to an embodiment, the robot control server 100 delivers firmware in an encrypted state to the robot 200. The reason is that there is a possibility of hacking, because the robot control server 100 supports web services using external networks providing online services to other websites or client-side applications, thereby preventing the risk of hacking between the robot control server 100 and the robot 200.

The robot 200 communicating with the robot control server 100 includes lower security. However, according to an embodiment, if receiving encrypted firmware, the robot 200 may store the encrypted firmware in the storage device 211, may load the encrypted firmware onto the memory 212 only at an update time point, and may decrypt the encrypted firmware, thereby solving the hacking risk. Moreover, as described above, the decrypted firmware loaded onto the memory 212 is completely deleted if the robot 200 is stopped or power of the memory 212 is cut off. Accordingly, even if the robot 200 is accessed in an illegal method, it is difficult to obtain firmware.

Furthermore, the CAN bus connecting the main controller 210 and the processor 222 is not secure. However, hacking is only possible with direct access to the CAN bus. This means there is a certain amount of hackability. However, according to an embodiment, the main controller 210 may fragment firmware delivered to each module 220 via the CAN bus into packets and may deliver the packets, and thus it is difficult to obtain the entire firmware even if the CAN bus is accessed and data is acquired and analyzed. Furthermore, it is difficult to obtain firmware unless the CAN communication of the robot 200 is hacked in real time by physically accessing the CAN bus while all the CAN communication specifications of the robot 200 are identified. In this way, an embodiment presents a firmware wireless update method specialized for CAN communication, thereby effectively helping to prevent hacking.

In FIG. 3, the main controller 210 and the processor 222 are electrically connected to the memory 212 and the internal memory 224 to control the overall operations and functions of the robot 200 and the module 220. In an embodiment, the main controller 210 may drive an operating system or an application program, and the processor 222 may control the hardware or software components included in the robot 200 by being driven via the firmware, and may perform various data processing and arithmetic operations. Moreover, the main controller 210 and the processor 222 may load commands or data received from at least one of the other components into the memories 212 and 224, may process them, and may store various pieces of data in the memories 212 and 224.

In an embodiment, each of the main controller 210 and the processor 222 may be implemented as a dedicated processor (e.g., an embedded processor) for performing the corresponding operations, or a general-purpose processor (e.g., a central processing unit (CPU) or an application processor (AP)) for performing the corresponding operations by executing one or more software programs stored in a memory device.

In an embodiment, each of the main controller 210 and the processor 222 may be implemented as a digital signal processor (DSP) that processes digital signals, a microprocessor, and a time controller (TCON). However, each of the main controller 210 and the processor 222 is not limited thereto, and may include one or more of a central processing unit (CPU), a micro controller unit (MCU), a micro processing unit (MPU), a controller, an application processor (AP), a graphics-processing unit (GPU), a communication processor (CP), or an address resolution protocol processor (ARP processor), or may be defined as the corresponding terms. Also, the processor may be implemented as large scale integration (LSI) or a system on chip (SoC) with built-in processing algorithms, or in a form of a field programmable gate array (FPGA).

In FIG. 3, the storage device 211, the memory 212, and the internal memory 224 are components for storing various programs and data necessary for the operation of the robot 200 and the module 220 in addition to controlling firmware data.

In an embodiment, the storage device 211, the memory 212, and the internal memory 224 may be implemented as a non-volatile memory, a volatile memory, a flash memory, a hard disk drive (HDD), or a solid state drive (SSD). The storage device 211, the memory 212, and the internal memory 224 are accessed by the main controller 210 and the processor 222, and data may be read/recorded/modified/deleted/updated by the main controller 210 and the processor 222. In an embodiment, the storage device and the memory may further include a RAM, a ROM within the processor, or a memory card (e.g., micro SD card, memory stick) mounted on the robot or the module.

Among the components illustrated in the robot 200 of FIG. 3, at least one component may be added, changed or deleted based on the performance and/or type of the robot 200. For example, the robot 200 may additionally include a component such as a display or a speaker. Furthermore, it should be easily understood by those having ordinary skill in the art that locations of the components may be changed to correspond to the performance or structure of the robot 200.

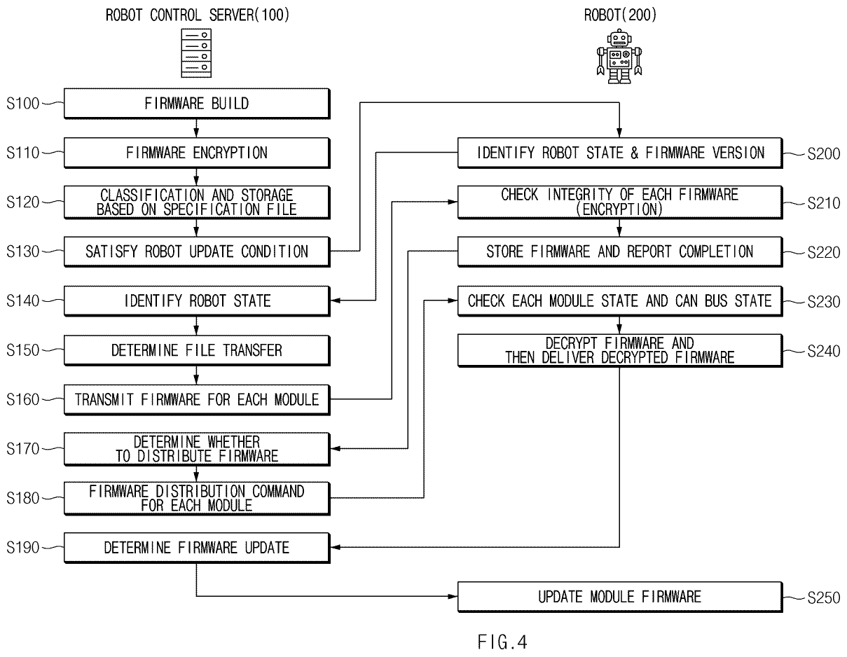

FIG. 4 is an overall flowchart illustrating a firmware wireless update process, according to an embodiment of the present disclosure.

Referring to FIG. 4, if the firmware development for each module 220 of the robot 200 is completed, the robot control server 100 may proceed with a firmware build (S100). During the firmware build, the firmware 231 includes information about the module 220 and the robot 200, which is a control target, and the firmware 231 is encrypted (S110). In the case, an encryption key used for encryption is not limited to a specific encryption key. For example, encryption processes may be performed by encryption keys presented by various encryption algorithms. Moreover, if the firmware build is in progress, the encryption algorithm using the encryption key may be built into a build server (not shown), and a new encryption algorithm may also be added.

The robot control server 100 may classify and store the encrypted firmware based on a specification file (S120). An example of classification and storage may be as shown in FIG. 2.

The robot control server 100 identifies that a condition for performing a firmware update on the robot 200 is satisfied (S130). If the condition is satisfied, the robot control server 100 identifies a robot state, a firmware version, or the like while communicating with the robot 200 (S200), and identifies the state of the robot 200 based on the identified result (S140). For example, the robot control server 100 may make a request for the robot state and firmware version information for each module of the robot to the robot 200, and may identify the robot state and the firmware version information transmitted by the robot 200.

If it is determined that a firmware update is possible (S150), the robot control server 100 transmits the encrypted firmware and a specification file to each robot 200 (S160). The firmware and the specification files transmitted at this time may include both firmware and a specification file for each of the modules 220.

The robot 200 performs a validation check for identifying the integrity of the received encrypted firmware, based on the specification file (S210). Herein, the validation check is used to determine whether the firmware is not damaged and is safe. In other words, this is to check whether there is an abnormality in the firmware. If abnormal firmware is updated without checking for the abnormality of the firmware, there is a possibility that the module 220 may not operate or malfunction. The robot 200 stores the firmware and delivers the check result of the abnormality to the robot control server 100 (S220). The check result may include whether the encrypted firmware is normal or abnormal.

The robot control server 100 determines whether to distribute firmware to modules requiring firmware updates based on the check results (S170). If determining that firmware distribution is possible, the robot control server 100 delivers a firmware distribution command for each module to the robot 200 (S180).

According to the firmware distribution command for each module, the main controller 210 of the robot 200 checks a CAN bus state and the state for each module (S230). In detail, the main controller 210 identifies the number and states of modules, which need to update firmware, and a current CAN bus state, and determines an individual transfer rate. The individual transfer rate is described below.

If the individual transfer rate (e.g., speed) is determined, the main controller 210 decrypts encrypted module-specific firmware stored in the memory 212 and delivers the decrypted firmware to each module 220 via the CAN bus (S240). Then, the processor 222 of each module 220 temporarily stores the decrypted firmware in the internal memory 224 and performs an integrity check. The processor 222 may provide feedback on the abnormality for the integrity check to the robot control server 100 via the main controller 210.

If the firmware to be updated is completely transmitted to each module based on the process, the robot control server 100 determines whether to perform the firmware update (S190). Moreover, if a firmware update is determined, the robot control server 100 delivers a firmware update command to the robot 200, and the robot 200 performs a firmware update for each module (S250). The processor 222 may perform an integrity check on the firmware stored in the internal memory 224 before the firmware update.

The firmware update is performed based on the module-specific update scenario. The update scenario is determined during a development step. For example, modules that do not interfere with the operation of the robot 200 may perform firmware updates during operation, and modules that do interfere may perform firmware updates in conjunction with a pause or reboot scenario. Moreover, if the update fails due to issues such as power failure during the firmware update, the update may be performed again after an automatic recovery to the initial firmware.

In this way, it may be understood that the robot 200 may transmit the decrypted firmware to each module by using a CAN bus and may perform a firmware update. Furthermore, it may be understood that the encrypted firmware data is transmitted via wireless communication between the robot control server 100 and the robot 200, the decrypted firmware data is transmitted via CAN communication between the robot 200 and the module 220, and firmware updates are performed. Thus it is possible to effectively respond to possible hacking threats.

Next, process-specific operations of FIG. 4 are described in more detail below.

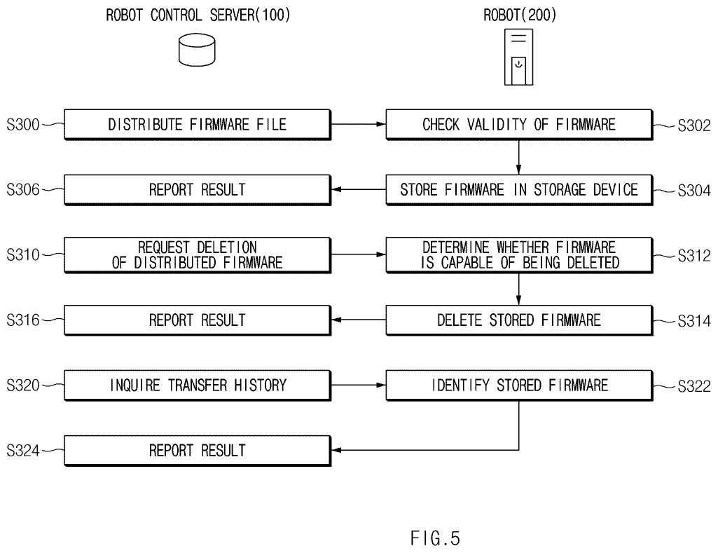

FIG. 5 is a flowchart illustrating in detail a process in which a robot control server delivers firmware data to a robot, according to another embodiment of the present disclosure.

The robot control server 100 may store, delete, and identify development data (firmware and a specification file) in the robot 200 based on an administrator's command.

If the robot control server 100 delivers encrypted firmware to each robot 200 (S300), the robot 200 may check the validity of the firmware (S302). Moreover, if the validity result indicates that the firmware is normal, the robot 200 may store the encrypted firmware in the storage device 211 (S304). Because the firmware stored in the storage device 211 is in an encrypted state, the security may be guaranteed even if the firmware is hacked or exposed illegally. The task of the robot 200 storing the firmware in the storage device 211 may be performed repeatedly multiple times based on the number of modules of each robot and the identified firmware version.

If the firmware is stored, the robot 200 reports the firmware storage result to the robot control server 100 (S306). This result reporting may be performed for each robot 200, and thus the robot control server 100 receives the results for each robot 200. The robot control server 100 may classify, and store modules and version information based on the reported results.

The robot control server 100 may request the robot 200 to delete the stored firmware (S310). If a request for deleting the firmware occurs, the robot 200 determines whether the firmware is capable of being deleted (S312). If the firmware is capable of being deleted, the robot 200 deletes the stored firmware (S314). If the firmware is deleted, the robot 200 may report to the robot control server 100 (S316).

The robot control server 100 may also request the robot 200 to identify the stored firmware. The identification request task may be a task of determining whether the transmitted firmware is normally stored (S320). If the robot control server 100 requests the robot 200 to inquire a firmware transfer history, the robot 200 may identify the firmware stored in the storage device 211 (S322), and may report the identified result to the robot control server 100 (S324).

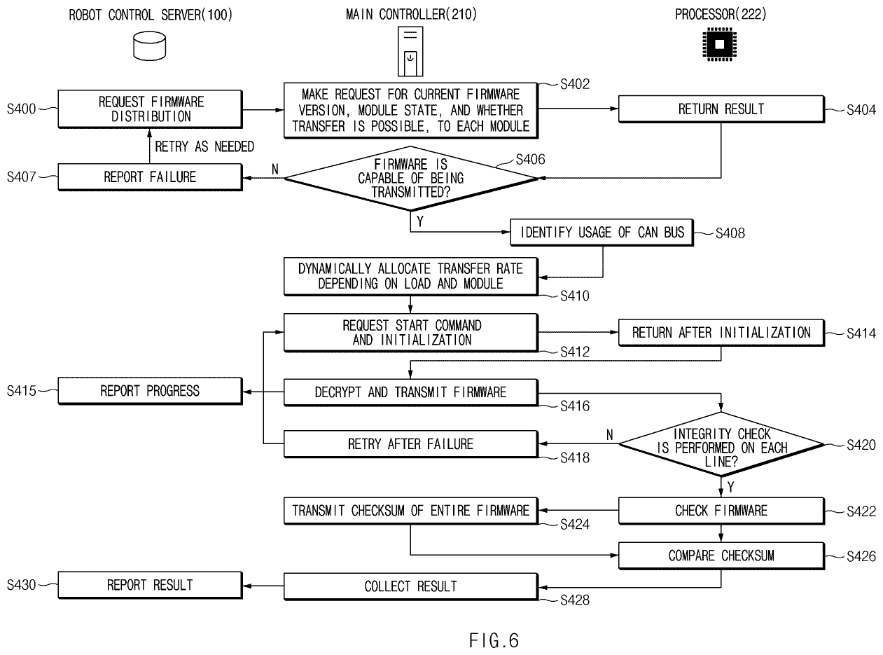

FIG. 6 is a flowchart illustrating a process, in which a main controller transmits firmware stored in a storage device to a processor, according to another embodiment of the present disclosure.

As mentioned earlier, the robot control server 100 may determine whether to distribute firmware for each module based on a robot state. If determining to distribute the firmware for each module, the robot control server 100 may request the robot 200 to distribute the firmware for each module (S400).

The main controller 210 of the robot 200, which receives a firmware request command, makes a request for a current module state, a firmware version, whether transfer is possible, and the like of each module 220 to the processor 222 of each module 220 (S402). Then, the processor 222 returns the request result to the main controller 210 (S404).

The main controller 210 may determine whether firmware is capable of being transmitted, based on the request result (S406). The main controller 210 prepares a process for transmitting the firmware to each module 220, based on the determined result, or if it is difficult to transmit the firmware based on a module state, the main controller 210 reports this to the robot control server 100 (S407).

If it is possible to transmit the firmware based on the determination of whether it is possible to transmit the firmware (Y in S406), the main controller 210 identifies the usage of a CAN bus connected to each module 220 (S408), and allocates the bus usage to each module 220 (S410). In the case, a transfer rate may be determined differently based on the allocated bus usage. The transfer rate may be controlled to decrease the transfer rate for each module if an excessive load additionally occurs while the firmware is transmitted to the module 220. Moreover, if there is a module that was terminated first while the firmware is transmitted, the transfer rate of the remaining modules may be controlled to increase. In other words, the firmware transfer rate via a CAN bus between the main controller 210 and each module 220 may be dynamically allocated based on the number of modules to which the firmware is transmitted. An example of allocating bus usage for each module and distributing firmware at different transfer rates is described in detail below.

The main controller 210 allocates bus usage to each module and then delivers a firmware transmission start command and an initialization request to the processor 222 (S412). Then, the processor 222 feeds back the processed result after the initialization to the main controller 210, and then the main controller 210 is in a state where the main controller 210 may distribute the firmware to each module 220.

To distribute the firmware, the main controller 210 accesses the encrypted firmware stored in the storage device 211, and stores the encrypted firmware in the memory 212. The main controller 210 also performs a process of decrypting the encrypted firmware by using an encryption key, divides the decrypted firmware into data pieces (e.g., packets) based on the transmission packet size, and transmits the data pieces to each module via a CAN bus (S416). In the decryption and transmission process, the main controller 210 may continuously report to the robot control server 100, such that the robot control server 100 may check the current situation.

If the packet is transmitted via the CAN bus, the processor 222 may perform an integrity check to determine whether there are an errors in each line of the packet (S420). The process involves waiting until all data for each line constituting the firmware is transmitted, checking for line errors, and then to verifying whether the corresponding line is complete if it is possible to check the line error. Moreover, an operation of checking the line error may be repeated by the processor 222 until all lines are received with reference to the total number of lines of firmware data. In the line error check, it may be checked whether the corresponding line is a complete line because the Intel hexa file, which is widely used as a firmware file, includes information such as the checksum, order, and length of one line. If an error occurs in the error check for each line of the packet, the main controller 210 may identify that there is an error in packet data. Accordingly, the main controller 210 repeats the process again from a step of requesting the firmware transmission start command and initialization (S418).

If all line error checks are completed (Y at S420), the processor 222 performs a check on the transmitted firmware (S422). The check on the firmware may include determining whether the firmware includes an over the air (OTA) function, whether the firmware is suitable for a module, or the like. Whether the OTA function included may be determined by determining whether all the corresponding keys are included as the firmware contains key values in an OTA-related class inside the firmware. The determination of whether the firmware is suitable for a module may be made by determining whether firmware includes a module's own ID and chipset ID. In this way, the processor 222 may determine whether the module is operating normally, and may include the OTA function such that an update is possible again later.

The processor 222 transmits the firmware check result to the main controller 210. Then, the main controller 210 delivers a checksum of the entire firmware file to the processor 222 (S424), and the processor 222 may compare the checksum of the current firmware, owned by the processor 222, with the checksum of the entire firmware transmitted by the main controller 210 (S426).

Afterwards, the main controller 210 receives the checksum comparison results for each module, collects the checksum comparison results (S428), and reports the collected result to the robot control server 100 (S430).

It may be understood that the process of comparing checksums in FIG. 6 is performed twice. In other words, it includes a process in which the main controller 210 compares the checksum for each line while transmitting a packet of firmware to the processor 222, and a process in which the processor 222 compares the entire checksum of the firmware. As a result, the integrity of firmware data may be completely secured.

According to an embodiment, if transmitting data to each module 220 via a CAN bus, the main controller 210 checks the usage of the CAN bus, and then allocates the bus usage to each module that updates the firmware. This is described with an example.

Compared to Ethernet communication, CAN communication includes a slow transfer rate, a limited number of IDs, and a small data size (fixed packet format) capable of being transmitted at one time. The maximum communication speed, ID bit length, maximum number of IDs, number of data bytes, and main uses based on known CAN communication standards may be as shown in Table 1 below.

TABLE 1

| | Maximum | | Maximum | | |
|---|---|---|---|---|---|
| | communica- | ID bit | number of | Data | |
| Standards | tion speed | length | IDs | bytes | Main uses |
| CAN 2.0A | 1 Mbps | 11-bit | 2048 | 8 | General vehicle |
| | | | | bytes | network |
| CAN 2.0B | 1 Mbps | 29-bit | 536,870,912 | 8 | If an extended |
| | | | | bytes | network is |
| | | | | | needed |
| CAN FD | 8 Mbps | 11/29- | Varies by | 64 | High-speed |
| | | bit | standards | bytes | communica- |
| | | | | | tion, large- |
| | | | | | capacity data |
| | | | | | transmission |

An embodiment may be based on CAN 2.0A standard. It is assumed that the size of a data packet is 11 bits, the transfer time per bit based on 1 Mps is 1 us, the maximum allowed bus usage rate A is 80%, the current bus usage rate B is 30%, and the bus usage margin C is 10%.

Under the conditions, there are four firmware update target modules. If all the four modules are capable of being transmitted immediately, the firmware transfer rate of each module is as follows.

An individual transfer occupancy rate becomes 10% based on equation “(A−B−C)/N”. Moreover, an individual transfer period is 1.11 milliseconds (ms) based on equation “(packet size*bit transfer time)/individual transfer occupancy rate”. As a result, the main controller 210 and the four modules that update firmware may transmit firmware data in parallel at a data transfer rate of 1 ms.

Furthermore, the firmware transfer may be temporarily stopped at a point in time at which the current bus usage rate B2 becomes 75% if the current bus usage rate B2 is “B2+(C/2)>A”, including the usage rate for transmitting firmware. Also, an individual transfer rate may be adjusted by again identifying the current bus usage rate B in a situation where firmware is not transmitted, and then calculating the individual transfer rate described above.

However, if the transfer cycle of each module is known, the firmware may be continuously transmitted by adjusting the transfer rate without stopping the transmission of firmware based on the bus usage rate. For example, if a firmware transfer cycle of an individual module is 1.11 ms, the firmware transfer occupancy rate is 40% based on equation “transfer cycle/transfer cycle*number of transmitting modules”. Accordingly, if the firmware transfer occupancy rate of 40% is subtracted from the bus usage rate B2 of 75%, the bus usage rate becomes 35%. Therefore, the individual transfer occupancy rate of each of the four modules becomes 8.7%, and firmware may be transmitted based on the individual transfer occupancy rate.

CAN 2.0A includes a maximum speed of 1 Mbps, and 2048 standard IDs. In CAN 2.0A, an extended ID may be used. However, for example, this may adversely affect communication speeds due to larger file headers.

Accordingly, according to an embodiment of the present disclosure, if CAN communication for a wireless firmware update is used, communication with a plurality of modules needs to be possible while limited command IDs are used. However, for example, because a plurality of modules using the same command ID may cause issues with transmission, the minimal number of command IDs needs to be assigned and managed in an embodiment of the present disclosure.

The minimum number of command IDs for a firmware update may be assigned by adding 1 (i.e. the first processor) to the number of modules.

The main controller 210 may assign one command ID to the processor 222.

The processor 222 may assign as many IDs as the number (N) of modules to the main controller 210. For example, if the command ID is assigned as “0x7N”, module A may be assigned as 0x70; module B may be assigned as 0x71; and, module C may be assigned as 0x72. Moreover, the processor 222 may identify a command ID sent to the processor 222 and may deliver the command ID to the main controller 210. For example, the processor 222 may add feedback to the transmitted field information and its own information. For example, if the main controller 210 and sends a command to the specific processor 222 while ‘1’ is included, the processor 222 may respond using command ID 0x71.

The present disclosure may assign an ID for OTA data in addition to the command ID. In other words, the ID for a command and the ID for data are separated from each other, thereby preventing various issues capable of occurring due to ID duplication and using a data field efficiently. Similarly to assigning a command ID, an ID assignment for OTA data is also assigned to the number of modules. For example, if the ID is assigned as 0x8N, module A may be assigned as 0x80; module B may be assigned as 0x81; and, module C may be assigned as 0x82. In the case, a firmware file is generated by cutting the firmware file based on the size of data capable of being transmitted.

Accordingly, even if there are 100 firmware OTA target modules of the present disclosure and there are a plurality of sub-modules constituting each module, a total of 201 IDs may be assigned to perform a firmware update.

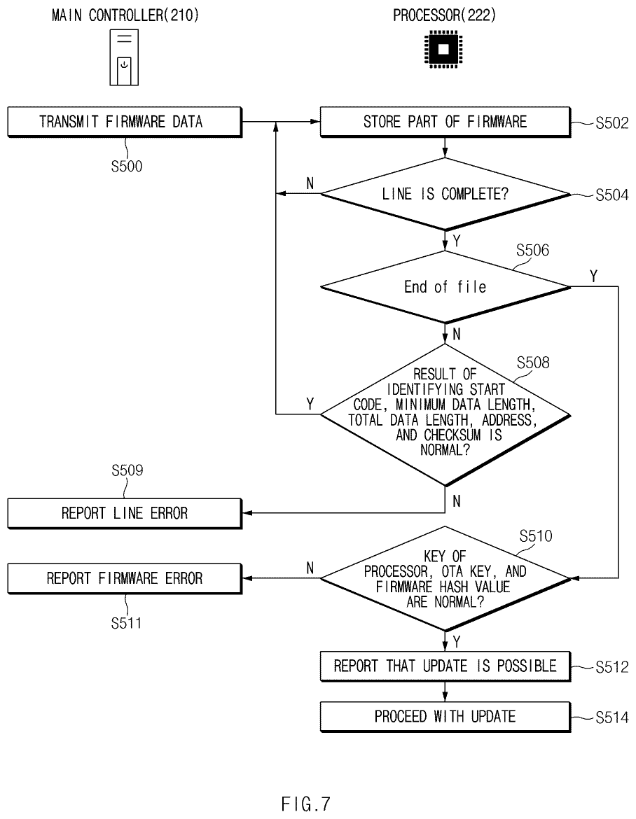

FIG. 7 is a flowchart illustrating a firmware update process of a processor, according to another embodiment of the present disclosure.

Referring to FIG. 7, if the main controller 210 transmits the decrypted firmware based on a transfer packet size (S500), the processor 222 determines whether a line is complete (S504) while storing the decrypted firmware (S502). Moreover, if one line is completed and then a line error check is possible, a start code, a minimum data length, a total data length, an address, a checksum, and the like for the one line are identified (S508). For example, the line error check operation may be performed repeatedly until the inspection of all lines of firmware data is completed (S506).

If there is no abnormality in the error check results for all lines based on the identification process (Y in S506), the processor 222 determines whether the firmware transmitted to the processor 222 is correct (S510). This may be done by checking a command key assigned to the processor 222, an OTA key, and a firmware hash value.

Furthermore, if the firmware transmitted to the processor 222 is correct, the processor 222 reports to the main controller 210 that an update is possible, and proceeds with the firmware update (S512, S514).

In FIG. 7, if an error occurs in a process of checking the result of a line and checking whether the firmware transmitted to the processor 222 is correct, the processor 222 immediately reports to the main controller 210 that there is a line error and a firmware error (S509, S511).

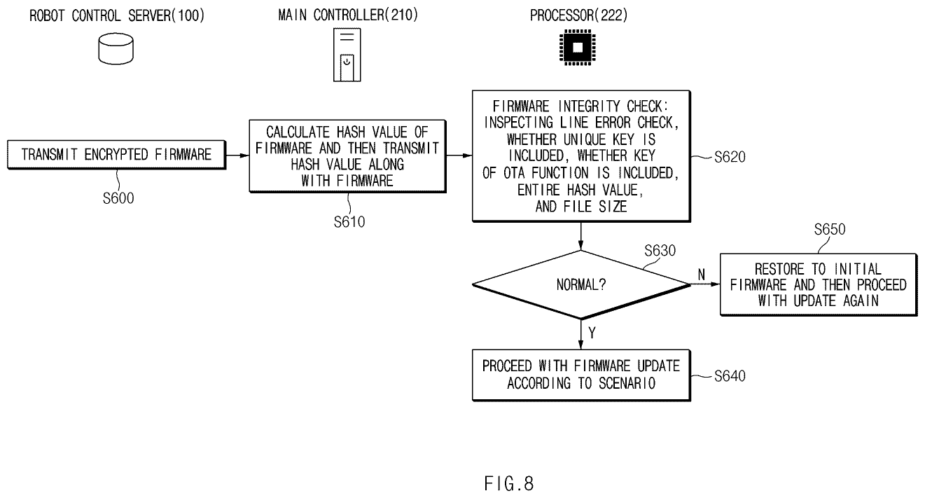

FIG. 8 is a flowchart specifically for describing a firmware integrity check process, according to another embodiment of the present disclosure.

It is important that firmware, which is sent to each module 220 of the robot 200 and then is updated, is checked for abnormalities before being updated. The reason is that if problematic firmware is updated, the corresponding module 220 may not operate or may malfunction, resulting in an accident. There may also be cases where a firmware update fails again due to an incorrect update.

A firmware integrity check process starts in response to the main controller 210 receiving encrypted firmware from the robot control server 100 (S600). Then, the main controller 210 calculates a hash value of the firmware and transmits the hash value to the processor 222 of each module 220 along with the firmware (S610).

The processor 222 identifies a firmware state by inspecting the result of the line error check of the firmware, whether a module's own unique key is included, whether a key of the OTA function is included, the entire hash value of the firmware, and a file size (S620). The line error checking may include a process of comparing checksums, data structures, data lengths, entire lines, and line numbers.

If no abnormality is found in the result of identifying the firmware state (Y of S630), the processor 222 determines that the firmware is normal and safe firmware, and proceeds with an update based on the set update scenario (S640). On the other hand, if the update fails due to a power failure or other issues during the firmware update, the processor 222 may detect the failure in a bootloader and perform the process of restoring to initial firmware and then again proceeding with the update (S650).

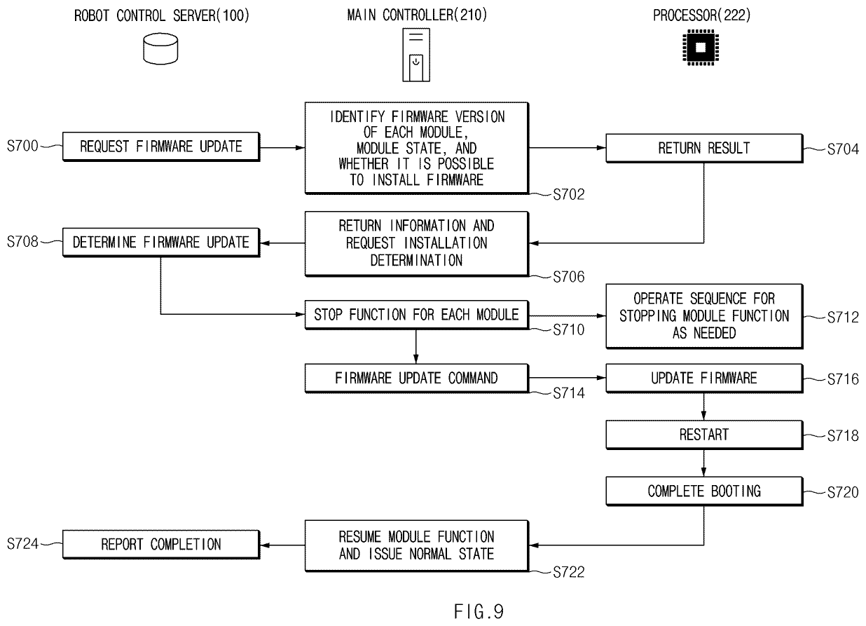

FIG. 9 is a flowchart for describing a firmware update process in detail, according to another embodiment of the present disclosure.

Referring to FIG. 9, the robot control server 100 requests a firmware update command in response to an administrator's command (S700). Then, the main controller 210 delivers the firmware update request to the processor 222 (S702).

The processor 222 identifies a version of firmware installed in each module, a module state, and whether it is possible to install firmware, and reports the results to the main controller 210 (S704). Then, the main controller 210 makes a requests for an update to the robot control server 100 with reference to the result reported by the processor 222 (S706). The robot control server 100 then determines whether to perform a firmware update, with reference to the result reported by the main controller 210 (S708).

If the robot control server 100 determines to perform a firmware update, the robot control server 100 notifies the main controller 210 of the firm update.

The main controller 210 requests the processor 222 to stop the function for the module to be updated based on the update scenario (S710). Then, the processor 222 may operate a sequence for stopping the function for the corresponding module (S712). Of course, for example, there is absolutely no need to stop the function of the module. In other words, a module that does not interfere with the operation of the robot 200 may update firmware while continuing to perform the function.

As described above, in a state where the function of the update target module is maintained or the function is stopped, the main controller 210 delivers a command for a firmware update to the processor 222 (S714). Then, the processor 222 updates the firmware by performing a firmware update process (S716). Furthermore, if the firmware update completes successfully, the processor 222 is restarted by the updated firmware and completes booting (S718, S720). Also, if the processor 222 completes booting, the main controller 210 identifies states of the firmware-updated modules and firmware version information. In addition, whether the firmware update was installed normally and whether the corresponding modules are operating normally is determined via firmware-updated information (S722).

Afterwards, the main controller 210 reports the results of the firmware-updated module to the robot control server 100 (S724).

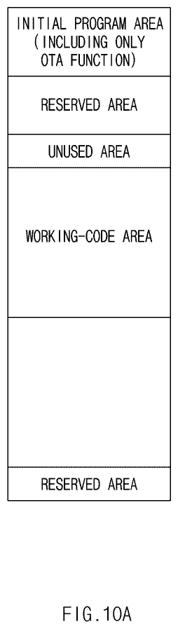

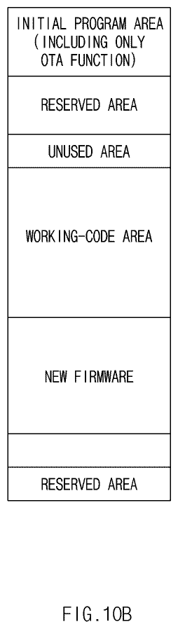

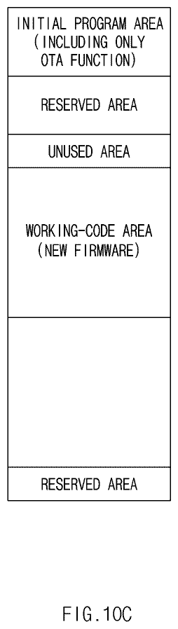

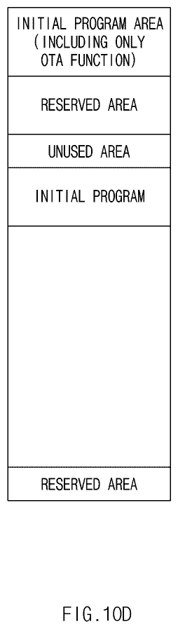

FIGS. 10A-10D are example diagrams illustrating a process of updating firmware in an internal memory.

As shown in FIG. 10A, the internal memory 224 may include an initial program area, a reserved area, an unused area, a working code area, and the like.

FIG. 10B illustrates a state where new firmware to be updated is loaded into the internal memory 224 based on a firmware update command. The new firmware to be updated may be loaded onto the unused area of the internal memory 224. The internal memory 224 may provide a plurality of unused areas. The new firmware is loaded into the unused area capable of being loaded by comparing a size of the new firmware to be updated with a size of the unused area.

FIG. 10C illustrates a state where the firmware is stored in the previously used firmware area after the firmware is completely updated. Moreover, if no new firmware update command is issued after the new firmware is updated, a module may perform an operation based on the updated firmware.

When a factory reset is required for the internal memory 224, an initial program may be installed in the firmware area of the internal memory 224 based on the factory reset command as shown in FIG. 10D. FIG. 10D illustrates the internal memory, which is in a factory initialized state before the firmware is loaded into any area of a memory area.

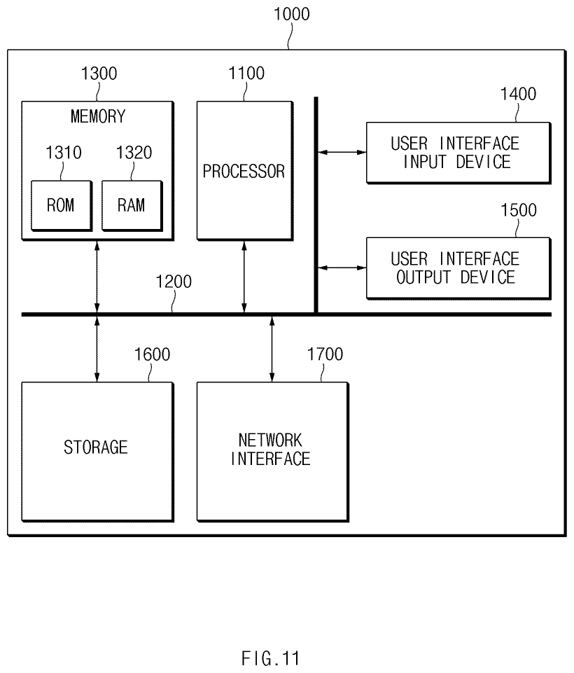

FIG. 11 is a block diagram illustrating a computing system, according to an embodiment of the present disclosure.

Referring to FIG. 11, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

As described above, an embodiment is described by using the at least one robot and CAN communication for convenience of description, but is not limited thereto. For example, it may be applied to other products with similar structures, such as vehicles instead of the at least one robot, and it may also be applied to Ether CAT, which is a communication method with a similar concept, not CAN communication. Moreover, the firmware update of the present disclosure may be automatically performed based on determined rules without intervention by an administrator.

The above description is merely an example of the technical idea of the present disclosure, and various modifications and variations may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

The present technology wirelessly updates firmware by using a OS-based main controller, which is equipped in a predetermined device and which is capable of performing external network communication with a plurality of modules connected to a CAN bus, as a gateway. As a result, the technology for wirelessly updating firmware helps to eliminate inconveniences for users who need to update firmware, and increase user satisfaction.

Moreover, the present technology may wirelessly update the firmware of many advanced modules used in technology fields such as the at least one robot and vehicles by wirelessly downloading and immediately updating modified or improved programs. As a result, the technology reduces management costs in the field of the at least one robot and vehicles that need to use CAN communication, and the present technology may be easily applied to existing systems without additional costs.

Furthermore, the present technology may increase the convenience of software development because each module, in which firmware is updated, shares the same structure.

Besides, a variety of effects directly or indirectly understood via the present disclosure may be provided.

Hereinabove, although the present disclosure was described with reference to various aspects and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

What is claimed is:

1. A system for a firmware wireless update, the system comprising:
a robot control server, and
at least one robot,
wherein the at least one robot includes:
a main controller, and
a module having a processor,
wherein the module is configured to communicate with the main controller, and
wherein the main controller is configured to perform a firmware update of the processor based on a firmware update command of the robot control server.

2. The system of claim 1, wherein the robot control server and the at least one robot are connected via a wireless network, and
wherein the main controller and the processor are connected via a controller area network (CAN) bus to perform the firmware update via CAN communication.

3. The system of claim 1, wherein the at least one robot further comprises:
a storage device configured to store encrypted firmware transmitted by the robot control server, and
a memory loaded to decrypt the encrypted firmware at a point in time of the firmware update,
wherein the main controller is configured to:
determine whether to decrypt the encrypted firmware based on the firmware update command;
split the decrypted firmware into packets of a predetermined size; and
deliver the packets to the processor, and
wherein the decrypted firmware is deleted from the memory.

4. The system of claim 1, wherein the robot control server is configured to:
encrypt firmware to include information about a robot to be updated at a firmware build and module information provided in the at least one robot.

5. The system of claim 3, wherein the main controller is configured to:
decrypt the encrypted firmware at a point in time at which controller area network (CAN) communication starts.

6. The system of claim 2, wherein the main controller is configured to:
allocate bus usage for each module based on a number of modules performing the firmware update, and usage of the CAN bus;
determine an individual transfer rate; and
transmit firmware to each module.

7. The system of claim 3, wherein the main controller is configured to:
perform a firmware integrity check on the encrypted firmware based on a specification file, and
wherein the processor is configured to:
determine whether to check firmware integrity based on firmware that is completely transmitted via controller area network (CAN) communication.

8. The system of claim 7, wherein the processor is configured to:
perform an error check on each line while receiving packet data of the firmware; and
determine whether to perform an integrity check on entire firmware when all lines are received.

9. The system of claim 1, wherein the module further comprises an internal memory, and
wherein the processor is configured to:
update firmware delivered by the main controller to a firmware area of the internal memory, which is being used when an operation of the module is suspended; and
resume the operation of the module by the updated firmware.

10. The system of claim 9, wherein the processor is configured to:
determine whether to perform the firmware update when restoring to an initial program based on the firmware update is not performed.

11. A method for wirelessly updating firmware using a system comprising a robot control server and at least one robot including a main controller and a module having a processor, the method comprising:
communicating, via the module, with the main controller, and
performing, via the main controller, a firmware update of the processor based on a firmware update command of the robot control server.

12. The method of claim 11, wherein the robot control server and the at least one robot are connected via a wireless network, and
wherein the main controller and the processor are connected via a controller area network (CAN) bus to perform the firmware update via CAN communication.

13. The method of claim 11, wherein the at least one robot comprises:
a storage device configured to store encrypted firmware transmitted by the robot control server; and
a memory loaded to decrypt the encrypted firmware at a point in time of the firmware update, and
wherein the method further comprises:
determining, via the main controller, whether to decrypt the encrypted firmware based on the firmware update command;
splitting, via the main controller, the decrypted firmware into packets of a predetermined size;
delivering, via the main controller, the packets to the processor; and
deleting, via at least one of the main controller, or the processor, or any combination thereof, the decrypted firmware from the memory.

14. The method of claim 11, further comprising, encrypting, via the robot control server, firmware to include information about a robot to be updated at a firmware build and module information.

15. The method of claim 13, further comprising, decrypting, via the main controller, the encrypted firmware at a point in time at which controller area network (CAN) communication starts.

16. The method of claim 12, further comprising:
allocating, via the main controller, bus usage for each module based on a number of modules performing the firmware update, and usage of the CAN bus;
determining, via the main controller, an individual transfer rate; and
transmitting, via the main controller, firmware to each module.

17. The method of claim 13, further comprising:
performing, via the main controller, a firmware integrity check on the encrypted firmware based on a specification file; and
determining, via the processor, whether to check firmware integrity based on firmware that is completely transmitted via controller area network (CAN) communication.

18. The method of claim 17, further comprising:
performing, via the processor, an error check on each line while receiving packet data of the firmware; and
determining, via the processor, whether to perform an integrity check on the entire firmware when all lines are received.

19. The method of claim 11, wherein the module further comprises an internal memory, and
wherein the method further comprises:
updating, via the processor, firmware delivered by the main controller to a firmware area of the internal memory, which is being used, when an operation of the module is suspended; and
resuming, via the processor, the operation of the module by the updated firmware.

20. The method of claim 19, further comprising:
determining, via the processor, whether to perform the firmware update when restoring to an initial program based on the firmware update not being performed.
